(19) United States
(12) Patent Application Publication
(10) Pub. No.: US 2010/0278620 A1
(43) Pub. Date: Nov. 4, 2010

(54) REFUSE RECEPTACLE LIFTER MOUNTING/WEIGHING ASSEMBLY

(76) Inventor: James R. Rimsa, Lombard, IL (US)

Correspondence Address: COOK ALEX LTD, SUITE 2850, 200 WEST ADAMS STREET, CHICAGO, IL, 60606, US

(21) Appl. No.: 12/757,708

(22) Filed: Apr. 9, 2010

Related U.S. Application Data
(60) Provisional application No. 61/175,123, filed on May 4, 2009.

(51) Int. Cl. B65F 3/02

(52) U.S. Cl. 414/408

(57) ABSTRACT

A lifter mounting assembly for a refuse receptacle lifter is disclosed. The lifter includes a fixed support adapted to be fixedly mounted to a refuse collection facility. A movable support is carried by the fixed support, with the movable support being adapted for mounting a refuse receptacle lifter thereon. The movable support is movable relative to the fixed support under force exerted by the lifter when lifting a refuse receptacle. A load cell is positioned for actuation by movement of the movable support relative to the fixed support.

### CROSS REFERENCE TO RELATED APPLICATION

This application claims the benefit of the filing date of U.S. Provisional Patent Application Ser. No. 61/175,123, filed May 4, 2008, the entire contents of which is incorporated herein by reference.

### BACKGROUND

The present invention generally relates to refuse collection apparatus and lifters for lifting and dumping refuse collection receptacles or containers. More specifically, the present invention relates to lifter mounting systems and assemblies for mounting lifters and for weighing the refuse collection receptacle and contents.

It has become common in many residential areas to use large, plastic roll-out refuse receptacles or containers that have a capacity of approximately 90 gallons, more or less. Typically, these refuse receptacles have two lifting handles, engagement surfaces or bars along a common exterior receptacle wall and two wheels for convenience in moving the receptacle. As a result of the large size and consequent weight when filled, these roll-out refuse receptacles are not easily lifted by hand. This has given rise to the development and use of refuse receptacle lifters specifically made for these larger roll-out receptacles.

Examples of commercially successful refuse receptacle lifters are the TuckAway® lifters manufactured by Perkins Manufacturing Company of LaGrange, Ill., and shown variously in U.S. Pat. Nos. 4,741,658, 4,911,600, 5,024,573, 5,069,593, 5,257,877, 5,466,110, and 6,503,045. These lifters typically include a carriage or face plate for engaging the refuse receptacle and an actuator for lifting, tilting (for dumping) and returning the receptacle to rest on the ground.

More recently, refuse collection companies have increasingly been concerned with efficiency and cost control, and increased consideration has been given to monitoring collection pickups, weighing the refuse collected and potentially directly charging customers based on quantity weight of refuse collected. As a result, collection companies have considered employing systems that weigh the receptacle or container contents as they are dumped and provide tracking of the particular container via electronic data base systems and associated telecommunications systems, which allow transmittal of the information from the collection vehicle directly to central data storage or central office systems for monitoring, billing and the like.

Various lifter systems or receptacle weighing and online communication systems have been previously proposed and are known in the refuse collection field. For example, these systems may incorporate a reader to read unique identifying information on the receptacle/container such as a bar code or radio frequency tag, which identifies the customer, the container and/or the waste hauler. The reader may provide data to on-site (or on-vehicle) or remote data storage devices and/or be in direct communication with an operations control center, including potential GPS input for monitoring the location of a collection vehicle. These features may be found in one or more of the various lifters and/or systems disclosed in the following documents, which are incorporated by reference in their entirety: U.S. Pat. Nos. 4,421,186; 4,645,018; 4,714,122; 4,824,315; 4,831,539; 4,839,835; 5,038,876; 5,119,894; 5,139,101; 5,195,418; 5,209,312; 5,230,393; 5,285,020; 5,287,855; 5,478,974; 5,630,227; 5,631,835; 5,666,295; 5,703,333; 5,824,963; 5,837,945; and 6,510,376, German Utility Model 69011382.9; German published application DE3819169 A1, and European published application 0292866 A2.

The present subject matter is not directed to such systems or software per se, but to a lifter mounting assembly or module for mounting refuse receptacle lifters and weighing refuse receptacles as they are dumped. Despite the extensive work already done in this field, continuing efforts are being made to develop a receptacle weighing systems that are versatile, economic, and reliable in the difficult environment associated with refuse collection systems.

### SUMMARY

In accordance with the subject matter described herein a low-profile lifter mounting assembly or module capable of receptacle weighing is provided. The illustrated embodiment of the lifter mounting assembly or module may be manufactured at relatively low cost, is relatively easy to install, allows for mounting lifters from various different manufacturers, adds only limited thickness to the lifter, does not increase the width of the lifter, provides load cell protection against excess force, and/or reduces potential interference with refuse that is collected.

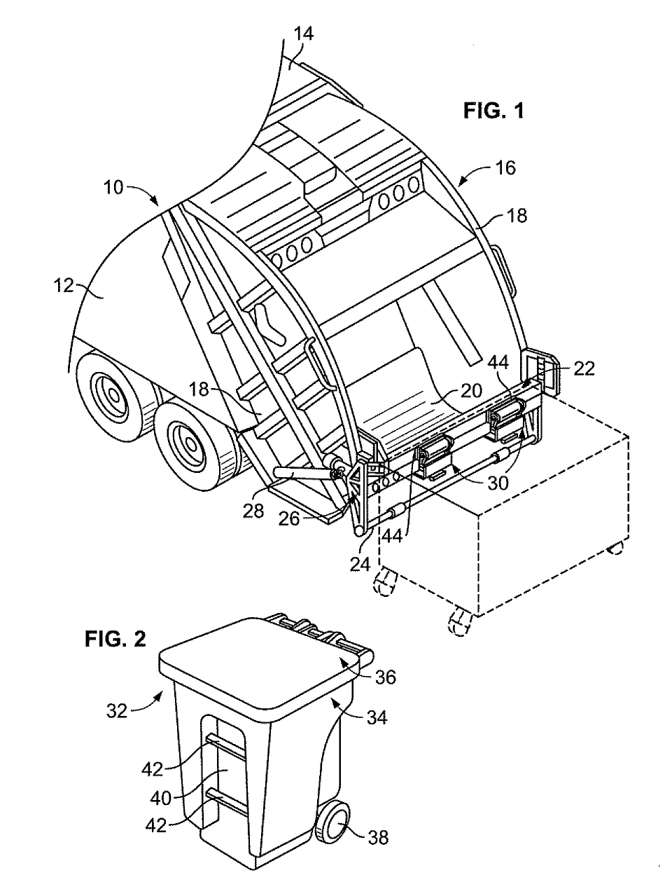

FIG. 1 is a fragmentary perspective view of a rear loading refuse collection vehicle including a pair of lifter mounting systems in accordance with the present subject matter, each mounting a hydraulic refuse receptacle lifter.

FIG. 2 is a perspective view of a typical residential refuse collection container or receptacle which may be used with the lifter and lifter mounting assembly of the present invention.

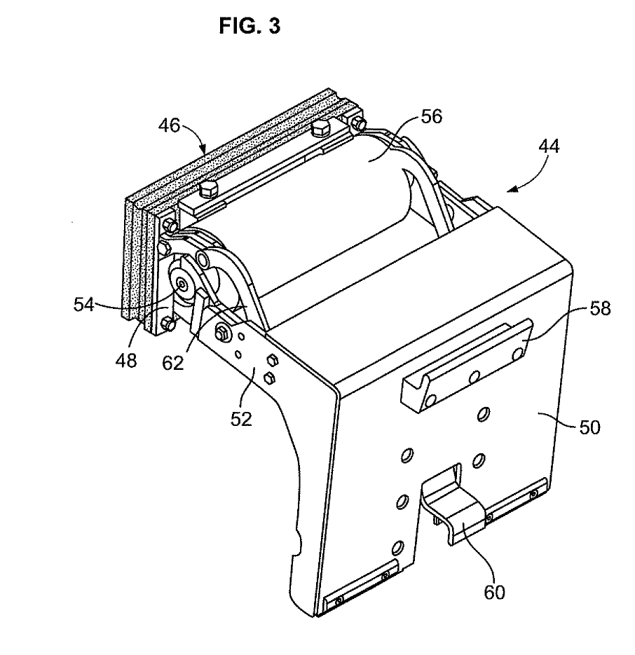

FIG. 3 is a perspective view of the lifter and lifter mounting assembly of FIG. 1 removed from the refuse collection vehicle.

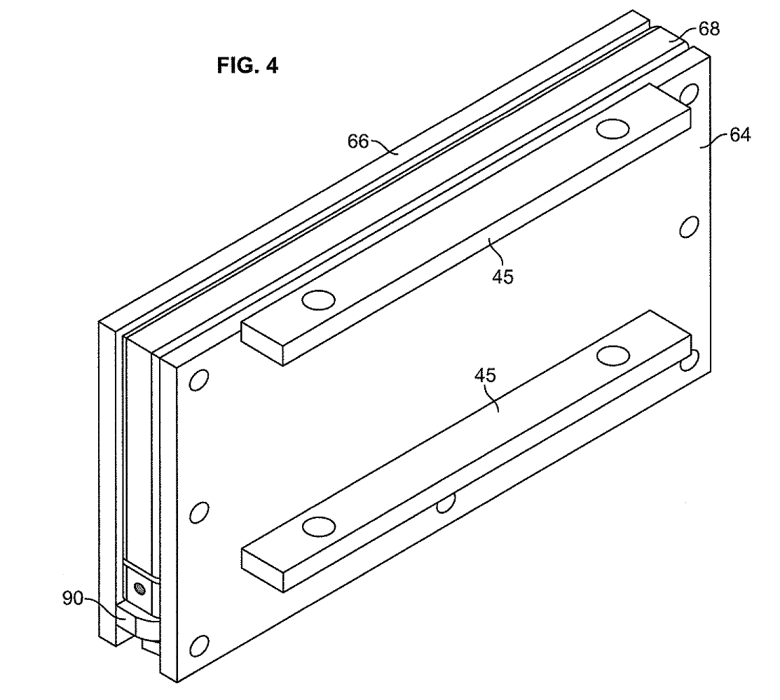

FIG. 4 is a perspective view of the lifter mounting assembly employed in FIGS. 1 and 3, viewed from the lifter side of the assembly.

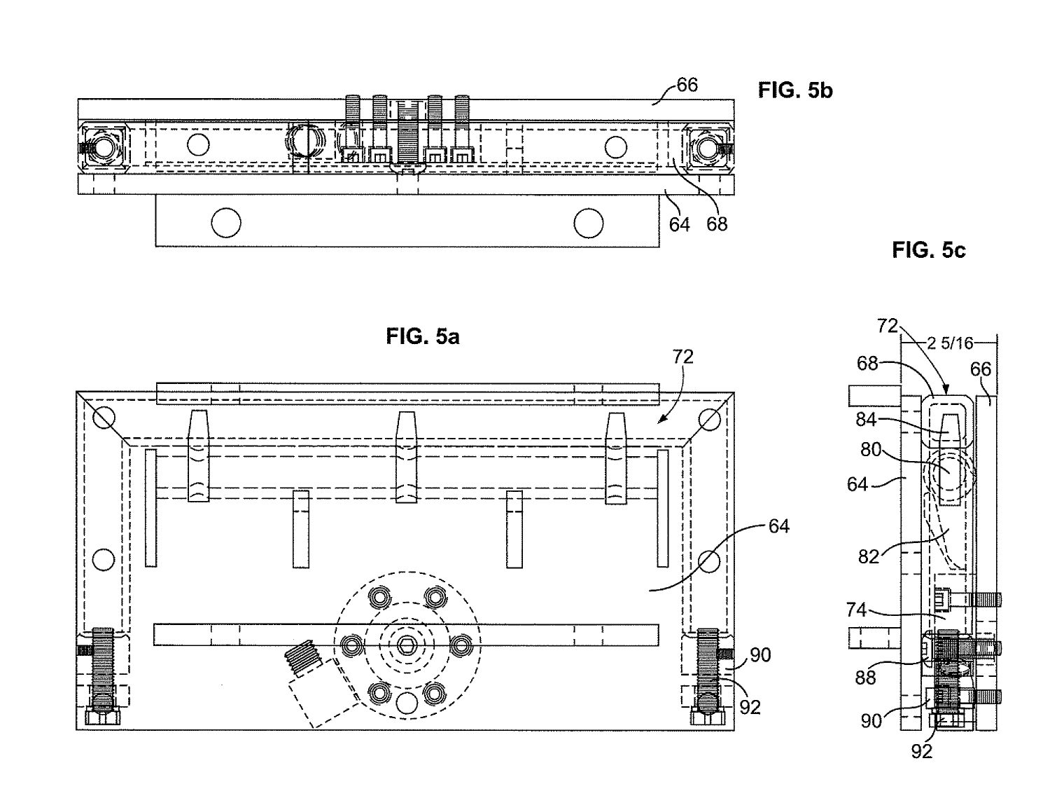

FIG. 5A is a view of the lifter mounting assembly of FIGS. 1, 3 and 4, without a lifter mounted thereon, taken from the lifter side of the assembly.

FIG. 5B is a top view of the lifter mounting assembly of FIG. 5A.

FIG. 5C is a side view of the lifter mounting assembly of FIG. 5A.

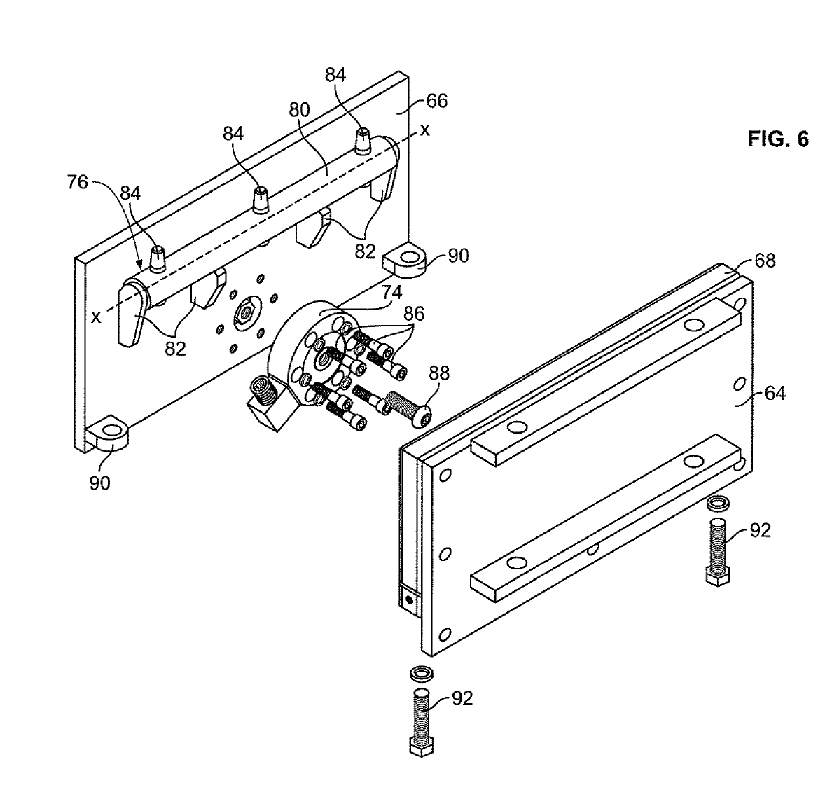

FIG. 6 is an exploded view of the lifter mounting assembly of FIG. 4.

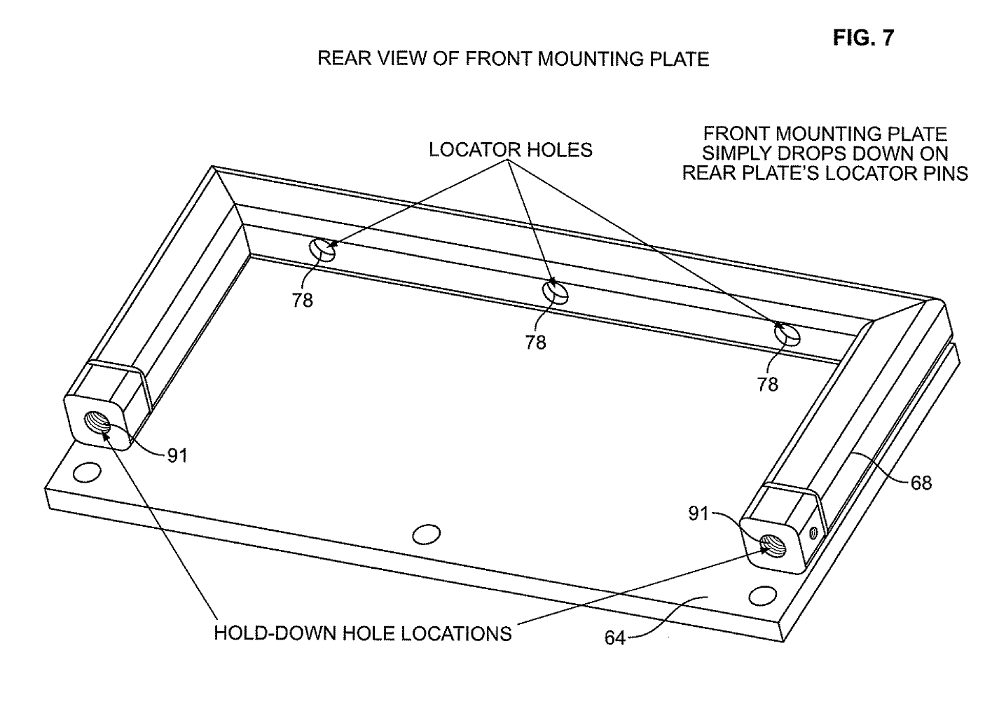

FIG. 7 is a rear perspective view of the lifter mounting plate of the lifter mounting assembly of FIGS. 4-6, taken from the side facing the vehicle.

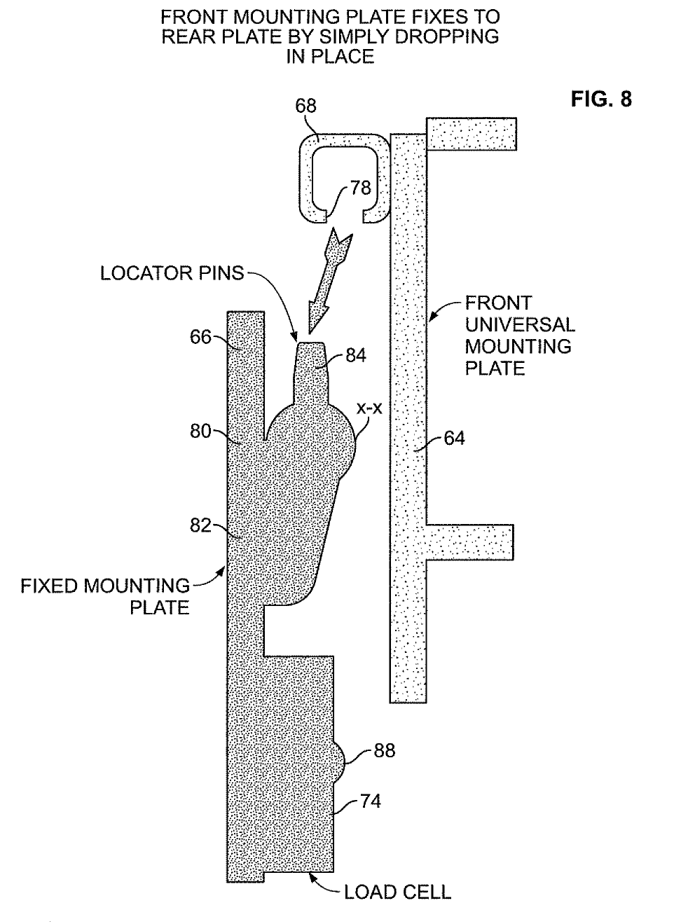

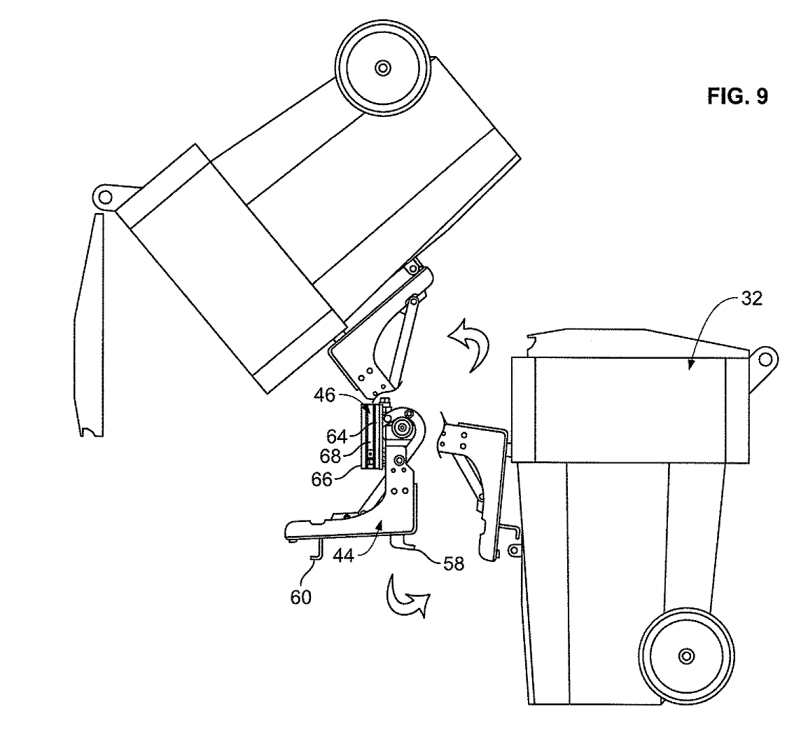

FIG. 8 is a side view of the lifter mounting assembly of FIGS. 4-6, illustrating assembly of the lifter mounting assembly.

FIG. 9 is a side, isolated view, illustrating a lifter, mounted on a lifter mounting assembly of FIGS. 4-6, with the lifter lifting a refuse receptacle and illustrating the refuse receptacle in different positions as it is lifted and dumped.

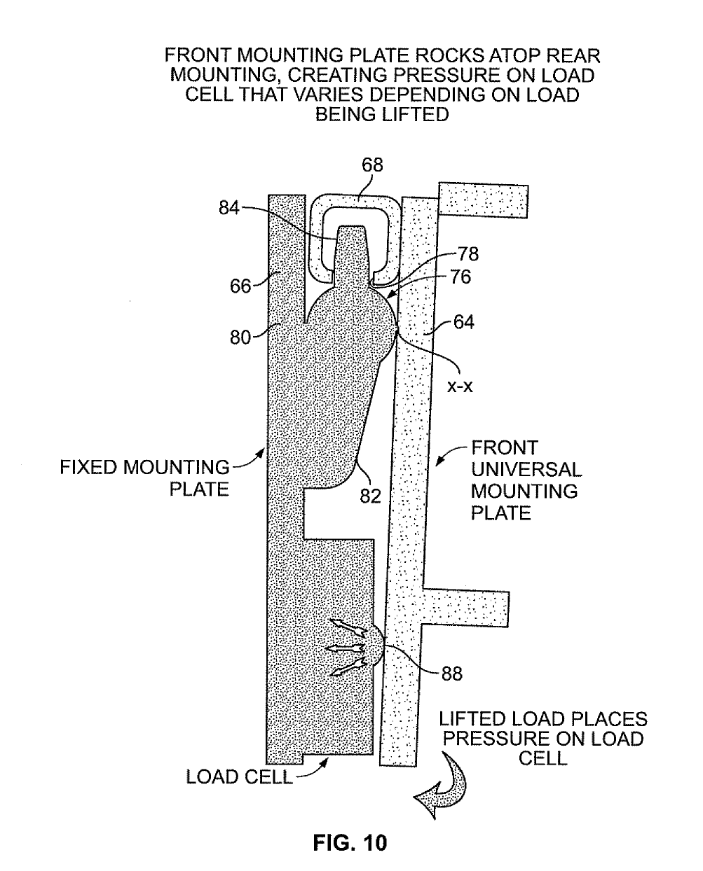

FIG. 10 is a side view of the lifter mounting assembly of FIGS. 4-6, illustrating forces that are applied to a load cell as the lifter is rotated.

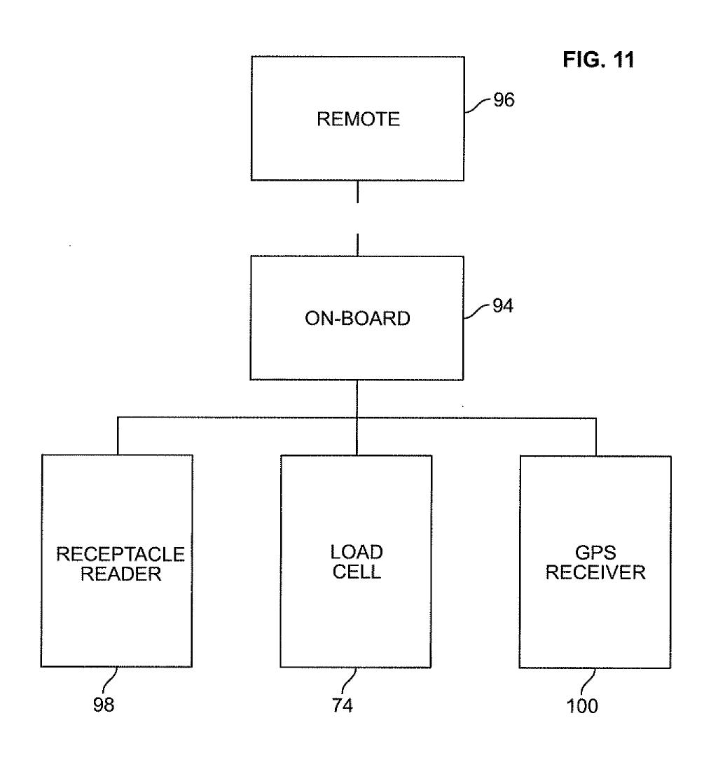

FIG. 11 is a block diagram of a data/communication system with which the lifter assembly may be used.

### DETAILED DESCRIPTION OF THE PREFERRED EMBODIMENT

With reference to FIG. 1, there is seen the rear portion of a typical rear-loading refuse collection truck, generally indicated by 10. The truck includes a refuse collection body defined generally by a pair of side walls 12, a top wall 14, and bottom wall (not seen). A rear-load hopper assembly, generally indicated by 16, is mounted at back of the collection body and includes side walls 18, and a curved bottom hopper wall 20. The bottom hopper wall 20 slopes upwardly toward a rearward sill or sill edge 22, over which refuse dumped into the collection hopper.

The rear load collection truck illustrated in FIG. 1 is adapted for dumping both very large, multi-cubic yard containers, commonly referred to as dumpsters, one of which is shown in dashed lines in FIG. 1, as well as much smaller residential-style containers, such as that shown in FIG. 2. For dumping the large containers, a tipper or kick bar 24 may be pivotally attached to the back of the truck by a bracket 26 that is rotated by a pair of hydraulic cylinders 28 (one shown).

For dumping smaller residential style refuse collection receptacles or containers (also called “carts”), the refuse collection truck 10 includes two lifter units, generally designated 30, mounted at the rear of the hopper by a lifter mounting assembly 44 as described herein. While the lifter units 30 are shown in connection with the particular truck, this is solely for purposes of illustration. The lifter units and associated mounting assembly described herein may also be used on trucks that are devoted solely to residential pick-up, on side load trucks, on multi-yard containers (both movable and stationary) with suitable hydraulic or other power attachments, or on portable or stationary dump stations or on other devices refuse collection facilities as may be useful.

A typical residential refuse container or cart 32 is shown in FIG. 2. The typical container 32 is made of rigid plastic construction with a body 34 and hinged lid 36. A pair of wheels 38 allow the container to be conveniently moved curb side, or to another pick-up location. The front side of the container includes a generally recessed area 40 to accommodate lifter units on the refuse collection vehicle. For cooperation with such lifters, a pair of parallel, spaced-apart engagement surfaces 42 are formed or secured in the container body in the recessed area 40. As illustrated, the engagement surfaces 42 may comprise parallel, spaced-apart lift bars 42 that are firmly secured to the container body in the recessed area. Other residential containers do not have bars, but have comparable functional structures molded into or otherwise attached to the container. The lid 36 is hingedly connected to the body, so that the lid is naturally open by gravity when the container is in routed for dumping. While a particular embodiment of a collection cart is shown in FIG. 2, they are available in a variety of styles and designs, and the present invention is not limited to any particular style or design of refuse collection container or refuse container lifter.

Turning to FIG. 3, there is shown in somewhat more detail a receptacle lifter or lifter assembly 44 and a lifter mounting assembly 46. The lifter 44 may be of any suitable design, and the present application is not limited to a particular type or style of lifter. Indeed, one aspect of the illustrated lifter mounting assembly 46 is that it provides a universal mounting arrangement for lifters of different design, depending on user preference. The illustrated lifter is one manufactured and sold by Perkins Manufacturing Co. of Romeoville, Ill., and described in more detail in U.S. Pat. No. 7,273,340, which is hereby incorporated by reference. But lifters from other manufacturers could also be used.

In general respects, the lifter or lifter assembly 44 includes a base 48 (which is attached directly to the lifter mounting assembly 46, described in more detail below) and a face plate or carriage 50 against which the collection cart 32 is positioned for dumping. A pair of lift arms 52 secures the carriage to the opposite ends of a rotatable shaft 54 of a hydraulic actuator 56, which is mounted to the base. The face plate or carriage 50 includes, as illustrated, an upper hook 58 and a lower hook 60 for engaging the lift bars or other engagement surfaces of the particular refuse receptacle or container. Actuator arms 62 move the lower hook 60 between a retracted and extended position as the lifter is rotated by the hydraulic actuator from a lower receptacle/container engaging position to a raised and inverted dumping position. As noted earlier, the particular lifter 44 shown in the drawings is for purposes of illustration only, and other lifters of different design or from different manufacturers may be employed in connection with the mounting assembly 46.

FIG. 4 is a perspective view of the lifter mounting assembly 46 illustrated in FIGS. 1 and 3, without a lifter attached. As may be seen there, the lifter mounting assembly is a relatively thin, low profile assembly, which includes a first support structure or mounting plate 64, a second support structure or mounting plate 66 and an intermediate member 68. Sometimes this assembly is described from the perspective of a person viewing the mounting assembly from the lifter side of the assembly (i.e., from the rear of a rear-loading collection truck) and the first or movable mounting plate may be called the front plate because it is closer to the viewer (even though it is the most rearward plate of the assembly 46 when it is mounted on a rear-loading truck) and the second or fixed mounting plate may be called a rear mounting plate because it is behind the movable or front plate from the perspective of the viewer. To reduce uncertainty and reduce confusion as to position, these structures or plates will be referred to herein as the first (or “movable”) mounting plate and the second (or “fixed”) mounting plate.

The illustrated first mounting support or plate 64 mounts the lifter 44 and is itself movably carried by the second mounting support or plate 66. The first mounting plate allows the assembly to accommodate any of a variety of lifters and is intended to be, in effect, a universal mounting plate, which may contain such attachment features as are desired for the particular lifter employed with the lifter mounting assembly, preferably without adding to the width of the lifter. As illustrated, for use with lifter 44 shown in FIG. 3, the front mounting plate includes an upper and lower mounting bars 45, predrilled for mounting to the base 48 of lifter 44. In addition, the front mounting plate is pre-drilled to mount support brackets for the lifter actuator arms 62. This mounting arrangement does not add width to the lifter or lifter mounting arrangement and is low-profile so as not to add significant depth or to unduly separate the lifter from the hopper or container. By not adding to the width of the lifter, the mounting assembly dimensionally accommodates mounting situations where multiple lifters are mounted side by side, as illustrated for example in FIG. 1.

The second mounting plate is adapted for fixed mounting relative to the first mounting plate. For example, the second mounting plate may be welded or bolted or otherwise attached to the hopper sill 22 of a refuse collection vehicle or to the wall of a large stationary or mobile collection container, to a dumping station or to other refuse collection facility, structure or device, such as a lift mechanism associated with the shredding apparatus or vehicle, such as marketed by Shred-Tech of Cambridge, Ontario, Canada.

The lifter mounting assembly 46 detects/determines the weight of the receptacle and its contents by transmitting torsional forces during the lifting of a receptacle to a load cell 74 associated with the lifter mounting assembly. More specifically, referring to FIGS. 5A-C, 6 and 7, it may be seen that the first mounting plate 64 is movably mounted to the second mounting plate, preferably by a fulcrum arrangement that allows the first plate to move or pivot relative to the second plate. More specifically, in the illustrated embodiment, the first and second plates cooperate through a pivot connector assembly generally at 72, which allows the front mounting plate to pivot or otherwise shift slightly under the weight of the receptacle being lifted to apply a compressive force to the load cell 74.

In the illustrated embodiment, the pivot connector assembly 72 comprises at least first and second engaging members that cooperate such that the first plate is carried by and movable relative to the second plate. The cooperative engaging members may take any suitable form such that the first plate (and the lifter mounted thereon) is carried by the second plate and is movable relative to the second plate to exert a force on the load cell. For example, one of the first or second structures or plates could include an engaging member in the form of a saddle or an aperture and the other plate could include a cooperative mating member such as a flange or pin.

In the particular structure shown in the attached drawings, one of the cooperating engagement structures is provided by the intermediate member 68, which is attached, such as by welding, to the facing surface of the first mounting plate 64 (see FIG. 7). The other cooperating structure is provided by a support member 76 that is attached, as by welding, to the facing surface of the second mounting plate (see FIG. 6). More specifically, in the illustrated embodiment the intermediate member 68 comprises a generally U-shaped member, such as a square steel tube (e.g. a 1.25 inch square steel tube), welded to the facing or inside surface of the first mounting plate 64. The steel tube includes at least one and preferably a plurality of locator holes or openings 78 for mounting the first plate on the second plate.

The illustrated support structure 76 comprises a horizontal support member 80, welded to the inside or facing surface of the second mounting plate by support flanges 82. The horizontal member 80 includes a plurality of upstanding locator extensions or pins 84. The locator pins and locator holes are sized to allow the upstanding pins 84 to extend into holes 78, so that the first plate and any attached lifter is supported by the fixed second plate. The locator pins and locator openings are sized so that the first plate is allowed a small amount of movement relative to the second plate, forward and away from the load cell 74. In the illustrated embodiment, that movement comprises a small relative pivoting motion, approximately about a horizontal axis x-x along the surface of horizontal member 80.

As shown, the load cell 74 is mounted to the surface of the second mounting plate by threaded connectors 86. The load cell may be of any suitable commercially available type of load cell which preferably operates by the application of compressive force to a force transmission member or surface, such as central member 88. Such load cells typically operate via transducers, wherein electrical resistance varies according to the force applied. Any suitable commercial load cell may be employed. One type of load cell that may be employed is a pancake compression/tension load cell, such as model no. 2430, made by Interface, Inc. of Scottsdale, Ariz. Another type of load cell is an “s-type” load cell, such as model SSM Sealed s-type also made by Interface, Inc. It is preferred that the load cell be selected so that it is suitable for accurately measuring the range of weights/forces likely to be encountered in lifting and dumping residential refuse collection containers. A load cell having a capacity up to about 5000 pounds of applied force against the force transmission member is believed to be suitable for the present lifter assembly, although other capacity load cells may be selected. This arrangement has been found to allow for a reliable and reproducible weighing of receptacle containers.

The load cell 74 may be mounted in any suitable fashion and may be mounted to either first or second plate or to other structure. Mounting of the load cell directly against the surface of one of the mounting plates provides protection against load cell overload. Because the illustrated load cell operates by application of compressive force by the front mounting plate against the force member 88, pushing the force member toward the rear plate, the surface of the rear plate acts as a backstop and prevents excessive deflection of the load cell toward the second plate. Accordingly, in circumstances where excess load is experienced (which can be, for example, by excess weight of a receptacle or by impact from backing a collection vehicle into an obstacle), the load cell will simply be pushed against the surface of the second mounting plate, and engagement against the second plate will prevent the load cell being deflected beyond its capacity, avoiding damage to an expensive load cell.

Although the pivot connector assembly 72 is depicted with the locator holes 78 in the intermediate member 68 attached to the first plate 64, and the locator pins 84 on the support member 80 (attached to the second plate 66, it should be apparent that these parts may be reversed and, if desired, the locator pins may be provided on the first plate and the intermediate member on the second plate. It may further be apparent that although the arrangement of locator pins and locator holes is particularly advantageous, it is not the only fulcrum structure that may be employed to allow relative motion between the first mounting plate and the second mounting plate, and other kinds of pivot arrangements may be employed as well. The illustrated structure does, however, allow particular ease of mounting of the lifter assembly and, additionally, with the intermediate member welded to the back of the face of the first plate, adds rigidity to the first plate as well. Further, the intermediate member 68 (without unduly increasing the thickness of the assembly 46) prevents refuse from entering or accumulating between the first and second plates 64 and 66. As may be seen in the figures the intermediate member fully occupies the space between the plates along the top edge and most of the side edges of the lifter mounting assembly 46. This creates a solid surface that prevents trash from lodging or falling between the plates.

FIG. 8 illustrates the ease with which the lifter mounting assembly 46 described herein allows attachment of a lifter to a refuse vehicle, the container or other device upon which it is attached. Specifically, the second or fixed mounting plate 66 is welded or otherwise attached to the vehicle, container or the like. The first or movable mounting plate 64 mounts the lifter and may be separately attached to the lifter 44 itself before mounting to the second plate. The first plate employes such mounting arrangement as may be necessary to the particular lifter assembly used. After the lifter is attached to first mounting plate, the lifter and attached first plate may be placed onto the second mounting plate, with the locator pins 84 extending into the matching locator holes or openings 78 of the intermediate member 68 attached to the first mounting plate. The respective locator pins and locator holes are sized to allow the first plate to pivot relative to the second plate, generally about axis x-x.

To prevent the lifter assembly 44 and first mounting plate 64 from accidentally lifting off the second mounting plate 66 (refer back to FIGS. 4 and 5), the second mounting plate includes a pair of brackets 90. Each of the brackets is drilled at 91 (FIG. 7) to receive a hold-down bolt 92 that extends through the bracket and into a threaded opening at the bottom of each leg of the intermediate member 68. The hold-down bolts keep the first mounting plate from lifting away from the second mounting plate under normal usage of the device, but still all sufficiently loose within brackets 90 to allow a relative movement or displacement of the front mounting plate with respect to the rear mounting plate so as to actuate the load cell. In the event excessive force is applied to the lifter, the bolts are designed to shear or break away. For example, if the lifter impacts the road surface during travel, the hold-down bolts 92 would break, permitting movement of the lifter in response to excessive force, thereby reducing potential lifter damage.

FIG. 9 illustrates the lifter 44 and lifter mounting assembly 46 during lifting of a typical residential refuse collection cart or receptacle 32. As noted earlier, the lifter and mounting assembly may be attached to a refuse collection vehicle (rear load or side load), to a refuse collection container, both movable and stationary, to a stationary lift station or in such other structure or refuse collection facility as may be desired. When not in use, the lifter 44 is normally located in a retracted position below the mounting assembly 46 as shown in FIG. 9. To engage the refuse receptacle, the hydraulic actuator rotates the lifter assembly counterclockwise. As the lifter assembly rotates, the upper hook 58 engages under the upper lift bar or engagement surface of the receptacle 32 and the lower hook 60 engages downwardly over the lower lift bar or engagement surface of the receptacle, capturing the receptacle on the face plate of the lifter. Continued rotation of the hydraulic actuator rotates the face plate and receptacle upwardly through an arc of approximately 120-180 degrees to a raised and inverted position at which point refuse is dumped into the particular refuse collection device.

In accordance with the present invention, as the receptacle 32 is lifted, gravitational force acting on the receptacle and lifter, creates torque or torsional force on the first plate and causes the front plate to pivot about the pivot connector assembly 72 and pushes the first mounting plate against the force transmitting member 88 of the load cell 74, with a force that is proportional to the weight of the lifter, the receptacle and the contents of the receptacle. In other words, the torque force is converted to a compressive force exerted on the load cell. The force exerted on the load cell may be measured when the receptacle is first lifted, during a range of the lifting motion or at a series of different points during the lifting and averaged to obtain the lifted weight. Similarly, the weight of the empty receptacle can be measured at one or more points or range of points as it is lowered and placed back onto the ground. The difference between the lifted weight and lowered weight would, of course, be the weight of the contents dumped into the vehicle, container or other depository.

As noted earlier, the container may employ a bar code, radio frequency tag or other source identifier, and the lifter could employ a radio frequency antenna/reader or bar code reader that communicates electronically with remote or on-board data handling systems for identifying the container, the customer associated with the container and for recording the weight of refuse dumped, time of dumping, location (if coordinated with GPS) and/or the like.

FIG. 11 is a block diagram illustrating the type of system in which the present collection container mounting system 46 may be used. The load cell 74 is electrically connected, by direct wire or wireless, with an on-board system 94 and/or via communication with a remote system 96 for determination of the weight of refuse dumped. The output of the data storage and/or container reader 98 and, if desired, a GPS system 100, may also be input to the on-board system and/or remote system to correlate the weight data with a particular receptacle and/or customer and with a particular location and/or pick-up time on a collection route. This information may be used, for example, during the initial portion of the dumping cycle, to determine that the container is, in fact, a container which should be collected by the particular waste collector. More specifically, if the bar code or radio frequency tag (and/or GPS location data) is read during the initial lifting of the container, before it is dumped, and it is determined by the on-board or remote system that the container is not one associated with a customer or with the particular customer in question, or for which a collection fee has not been contracted or paid, then the dumping can be interrupted and the container placed back on the ground without dumping. Further, identification of the container allows the waste hauler to confirm the particular customer associated with that container for purposes of invoicing or billing the customer based on the weight of the refuse collected. The data can be used for other multiple other purposes as well, as determined by the particular waste collector.

Following from the above description and exemplary embodiments, it should be apparent to those of ordinary skill in the art that, while the foregoing constitute exemplary embodiments of the present disclosure, the disclosure is not necessarily limited to these precise embodiments and that changes may be made to these embodiments without departing from the scope of the invention as defined by the claims. Additionally, it is to be understood that the invention is defined by the claims and it is not intended that any limitations or elements describing the exemplary embodiments set forth herein are to be incorporated into the interpretation of any claim element unless such limitation or element is explicitly stated. Likewise, it is to be understood that it is not necessary to meet any or all of the identified advantages or objects of the disclosure discussed herein in order to fall within the scope of any claims, since the invention is defined by the claims and since inherent and/or unforeseen advantages of the present disclosure may exist even though they may not have been explicitly discussed herein.

1. A lifter mounting assembly for a refuse receptacle lifter, comprising:
a fixed support adapted to be fixedly mounted to a refuse collection facility;
a movable support carried by the fixed support, the movable support being adapted for mounting a refuse receptacle lifter thereon, the movable support being movable relative to the fixed support under force exerted by the lifter when lifting a refuse receptacle; and
a load cell positioned for actuation by movement of the movable support relative to the fixed support.

2. The lifter mounting assembly of claim 1 wherein said movable support is pivotally movable relative to the fixed support.

3. The lifter mounting assembly of claim 1 further comprising a fulcrum assembly associated with the fixed and movable supports to allow pivotal movement of the movable support relative to the first.

4. The lifter mounting assembly of claim 3 wherein the fulcrum assembly includes cooperative locator structures for locating the movable support relative to the fixed support.

5. The lifter mounting assembly of claim 4 in which the lifter structure includes a locator member mounted on one support and a locator member receiver mounted on the other support.
